(19) United States
(12) Patent Application Publication
(10) Pub. No.: US 2021/0065166 A1
(43) Pub. Date: Mar. 4, 2021

(54) SYSTEMS AND METHODS FOR SUPPLIER INTEGRATION

(71) Applicant: JPMORGAN CHASE BANK, N.A., New York, NY (US)

(72) Inventors: Laura A. HIGGINS, Hillsborough, CA (US); Douglas ROGINSON, Columbus, OH (US); Julianne VICCIARDO-GORDON, Avondale, PA (US); Ramesh KASAM, Powell, OH (US)

(21) Appl. No.: 17/006,176

(22) Filed: Aug. 28, 2020

Related U.S. Application Data
(60) Provisional application No. 62/893,681, filed on Aug. 29, 2019.

(51) Int. Cl. G06Q 20/38; G06Q 20/40

(52) U.S. Cl. CPC G06Q 20/388; G06Q 20/3821; G06Q 20/4016

(57) ABSTRACT

Systems and methods for supplier integration are disclosed. In one embodiment, in an information processing apparatus comprising at least one computer processor: a method for providing supplier-requested information may include: (1) receiving a request for information from a supplier representative using a supplier application executed by a supplier electronic device; (2) authenticating the supplier application; (3) retrieving the information from a plurality of systems; (4) aggregating the retrieved information; (5) determining an entitlement level for the supplier representative; and (6) communicating the aggregated retrieved information in accordance with the entitlement level to the supplier electronic device.

### RELATED APPLICATIONS

This application claims priority to, and the benefit of, U.S. Provisional Patent Application Ser. No. 62/893,681 filed Aug. 29, 2019, the disclosure of which is hereby incorporated, by reference, in its entirety.

### BACKGROUND OF THE INVENTION

### 1. Field of the Invention

The present disclosure generally relates to systems and methods for supplier integration.

### 2. Description of the Related Art

Suppliers to an organization often have little, if any, visibility into their performance. And when feedback is provided, it is often too late for the supplier to recover. The organization often treats the suppliers as siloed, and get little, if any, metrics from the relationship.

### SUMMARY OF THE INVENTION

Systems and methods for supplier integration are disclosed. In one embodiment, in an information processing apparatus comprising at least one computer processor: a method for providing supplier-requested information may include: (1) receiving a request for information from a supplier representative using a supplier application executed by a supplier electronic device; (2) authenticating the supplier application; (3) retrieving the information from a plurality of systems; (4) aggregating the retrieved information; (5) determining an entitlement level for the supplier representative; and (6) communicating the aggregated retrieved information in accordance with the entitlement level to the supplier electronic device.

In one embodiment, the method may further include determining that the information in the request comprises restricted information may include at least one of an invoice amount, payment information, an account number, a risk issue, performance data, and a supplier specific scorecard; and authenticating the supplier representative.

In one embodiment, the authentication may include full authentication or light authentication.

In one embodiment, the method may further include determining that the information in the request may include non-restricted information comprising at least one of an invoice date, an invoice status, a notification, and an alert.

In one embodiment, the step of aggregating the retrieved information may include merging the retrieved information from the plurality of systems into a single graphical representation.

In one embodiment, the supplier application may be authenticated if it is a registered application.

In one embodiment, the aggregated retrieved information may be graphically presented in a dashboard.

In one embodiment, the requested information may include a request for data aggregation, consolidation, or mapping.

According to another embodiment, in an information processing apparatus comprising at least one computer processor, a method for providing supplier-requested services may include: (1) receiving a request for a service from a supplier representative using a supplier application executed by a supplier electronic device; (2) authenticating the supplier application; (3) determining an entitlement level for the supplier representative; and (4) providing access to the service in accordance with the entitlement level on the supplier electronic device.

In one embodiment, the method may further include determining that the requested service is a restricted service comprising at least one of worker onboarding, invoice submission, or supplier set-up; and authenticating the supplier representative.

In one embodiment, the authentication may include full authentication or light authentication.

In one embodiment, the method may further include determining that the service is a non-restricted service; and providing access to the non-restricted service on the supplier electronic device.

According to another embodiment, in an information processing apparatus comprising at least one computer processor, a method for providing internal supplier review information may include: (1) receiving a request for supplier information from an internal user using an internal user application executed by an electronic device; (2) retrieving the supplier information from a plurality of systems; (3) aggregating the retrieved supplier information; and (4) communicating the aggregated supplier information in accordance with the entitlement level to the electronic device. The aggregated supplier information may be graphically presented on the electronic device.

In one embodiment, the request may identify a specific supplier, a category of suppliers, etc.

In one embodiment, the request is for supplier information that may include performance, usage data, risk, etc.

In one embodiment, certain information in the aggregated supplier information may be displayed in a highlighted manner.

In one embodiment, the aggregated supplier information may include aggregated supplier information for a plurality of suppliers.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for supplier integration according to one embodiment;

FIG. 2 depicts a method for supplier integration according to one embodiment;

FIG. 3 depicts an exemplary process flow for a method of providing supplier-requested services;

FIG. 4 depicts an exemplary process flow for a method of providing supplier-requested data aggregation, consolidation, and mapping according to embodiments;

FIG. 5 depicts an exemplary process flow for a method for internal supplier review according to embodiments;

FIGS. 6A-6E depict exemplary graphical user interfaces according to embodiments.

### DETAILED DESCRIPTION OF PREFERRED EMBODIMENTS

Embodiments are directed to systems and methods for supplier integration. Embodiment may provide a central place for supplier to interact. It may provide functionality for suppliers to understand their positions, and functionality to help the suppliers to do business with the organization. Embodiments may provide services to assist with onboarding suppliers, contractors, vendors, etc. For example, the services may include streamlining applications for background checks, fingerprinting, badging, etc.

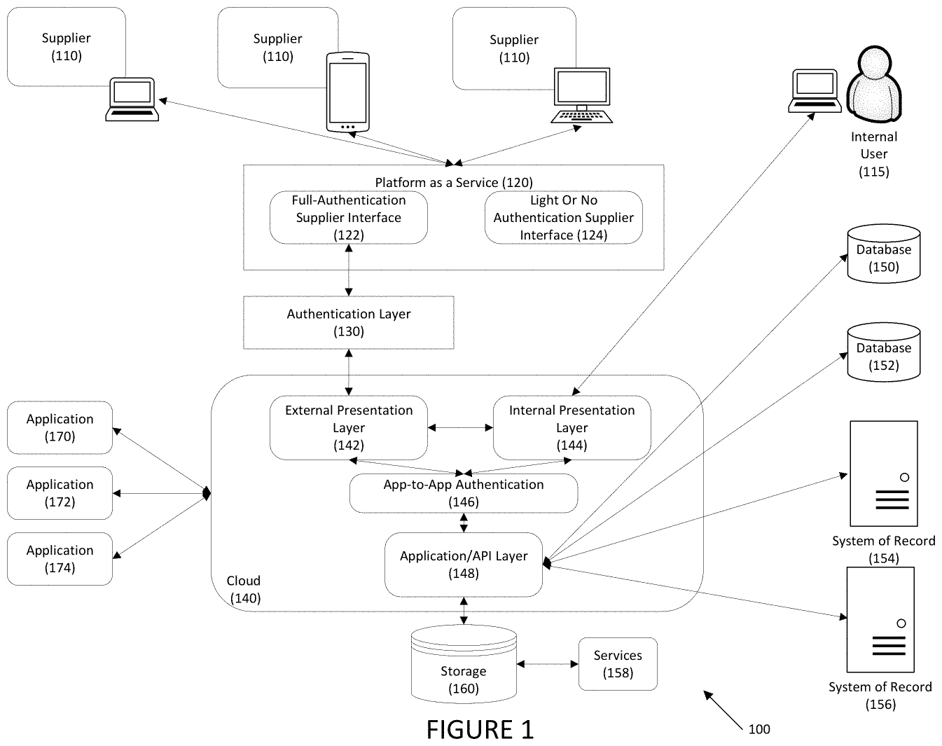

Referring to FIG. 1, a system for supplier integration is provided according to one embodiment. System 100 may provide access to external presentation layer 142 for suppliers 110 and to internal presentation layer 144 for internal users 115.

In one embodiment, supplier 110 may be an organization, an individual, etc. Suppliers 110 may provide tangible goods or services, intellectual goods or services, etc.

Suppliers 110 may access external presentation layer 142 using a credentialed login (e.g., a username and password, etc.). Suppliers 110 may be authenticated by authentication layer 130. Depending on the level of authentication required, authentication may be provided by full authentication supplier interface 122 in PaaS 120 and light or no authentication supplier interface 124.

Suppliers 110 may also external presentation layer 142 without having a credentialed login, or with light authentication. For example, light or no authentication supplier interface 124 may be provided for such authentication. For example, suppliers 110 may access the system to inquire about an invoice, etc. In one embodiment, suppliers 110 may be lightly authenticated by providing one or two pieces of information.

External presentation layer 142 and internal presentation layer 144 may be provided in, for example, cloud 140. In one embodiment, cloud 140 may be a private cloud that may be maintained within the organization. In one embodiment, firewalls, proxies, etc. may be provided as is necessary and/or desired.

External presentation layer 142 and internal presentation layer 144 may be provided in other ways as is necessary and/or desired.

In one embodiment, external presentation layer 142 may render information to suppliers 110 and internal presentation layer 144 may render information to internal users 115. Application and API layer 148 may conduct API calls and/or database links to retrieve information for suppliers 110 and/or internal user 115, such as financial information, conformance information, risk and control issues, etc. In one embodiment, the information may be retrieved from databases 150, 152, systems of record 154, 156, etc. Any suitable data source may provide information as is necessary and/or desired.

In one embodiment, the information may be used to generate and/or populate one or more widgets that may be provided in a dashboard by external presentation layer 142 and internal presentation layer 144.

In one embodiment, suppliers 110 may further request a service, such as onboarding information, background checks, credential generation, etc. using services 158. In one embodiment, services 158 may access data in storage 160. For example, storage may provide suppliers with access to documents that they upload or documents that are uploaded by the organization.

In one embodiment, one or more application 170, 172, 174 may be provided that may be launched from the cloud. In one embodiment, presentation engine 145 or another engine (not shown) may provide information to one or more application 170, 172, 174 which may process the information. In one embodiment, application 170, 172, 174 may be external applications; in another embodiment, application 170, 172, 174 may be executed in cloud 140.

For example, one or more application 170, 172, 174 may provide tools to supplier 110 and/or internal user 115. In one embodiment, presentation engine 145 may retrieve results from one or more application 170, 172, 174 and may render the results.

In one embodiment, external presentation layer 142 and internal presentation layer 144 may not store information that is retrieved, but may instead call and retrieve the information on-demand. In one embodiment, user identifications, internal user associations with suppliers, credentials, etc. may be stored as is necessary and/or desired.

App-to-app authentication 146 may provide security across multiple tiers of the application. In embodiments, this may ensure that there is a trusted connectivity for data exchange between presentation layers 142 and 144, and application/API layer 146.

In one embodiment, external presentation layer 142 and internal presentation layer 144 may provide suppliers 110 and/or internal user 145 with the following information: real-time category taxonomy and spend/revenue data; onboarding and status; invoice status and look-up, performance scorecard, organization news, guidelines, calendar of events, targeted communications, risk items, action plans, due dates, key contacts, helpful links to tools, etc. It may further provide alerts (e.g., email, SMS, push, etc.).

In one embodiment, internal user 115 may be provided with information to facilitate comparison of a plurality of suppliers 110. Machine learning may be used to identify suppliers that are performing well; this information allows a user to engage a supplier and provide suggestions to improve the performance of suppliers with deficient performance.

Embodiments may further provide predictive analysis for supplier performance or supplier financial viability. In one embodiment, integration with other organization system may be provided so that other financial information for the supplier, historical supplier data, etc. may be retrieved, which allows a user to make better buying decisions because additional data points about the supplier are made available.

Embodiments may further provide seamless login across other organization system, expiring contract information, enhanced financial information, supplier upload functionality, customizable performance management widgets, contract recertification, active RFP/bidding lists, CRM functions, electronic tax forms, etc. The supplier or the organization may issue surveys, etc.

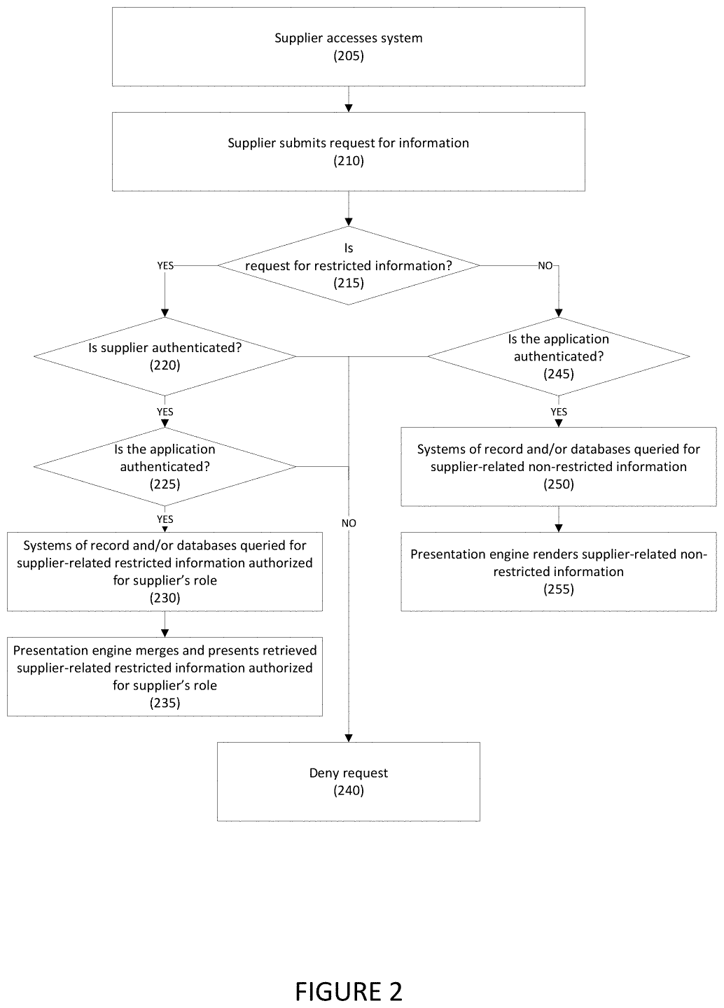

Referring to FIG. 2, an exemplary process flow for a method of providing supplier-requested information is provided according to embodiments.

In step 205, a supplier may access the system using, for example, an electronic device, and in step 210, may request information. The request may be for restricted information, or for non-restricted information. Examples of restricted information may include invoice amounts, payments, account numbers, supplier contact information, risk issues, performance data, supplier specific scorecards, etc.

Examples of non-restricted information may include invoice dates, invoice statuses, news and information, notifications, alerts, etc.

In one embodiment, supplier information that may be requested may include supplier performance data (e.g., high, low medium performance scores, the reasons for the performance scores, etc.), supplier performance to other suppliers, actions that are past due, actions that are coining due, etc.

In step 215, if the request is for restricted information, in step 220, the supplier may be authenticated. In one embodiment, full authentication may be used; in another embodiment, light authentication may be used. The type of authentication may depend, for example, on the type of supplier, the relationship with the supplier, other credentials that may assist with authentication, etc.

If the supplier is authenticated, in step 225, the application may be checked to see if it is authenticated, such as a registered application, a registered IP address, etc. If the supplier or the application are not authenticated, in step 240, the request may be denied.

If the application is authenticated, in step 230, the relevant systems of record may be queried for the supplier information. For example, all systems of record may be queried. In another embodiment, only systems of record with information relevant to the request may be queried. In another embodiment, machine learning and/or artificial intelligence may be used to identify the systems of record to query.

In one embodiment, data may be de-duplicated as is necessary and/or desired.

In step 235, the presentation engine may merge the retrieved supplier information and may present the merged supplier information that is authorized for the supplier's and/or the specific requesting individual's role. The merged supplier information may be presented graphically in a dashboard.

If, in step 215, the request is for non-restricted information, in step 245, a check may be made to see if the application is authenticated. This may be similar to step 220. If the application is authenticated, in step 250, the relevant systems of record may be queried for the supplier information. This may be similar to step 230, above.

In step 255, the presentation engine may merge the retrieved supplier information and may present the merged supplier information. The merged supplier information may be presented graphically in a dashboard.

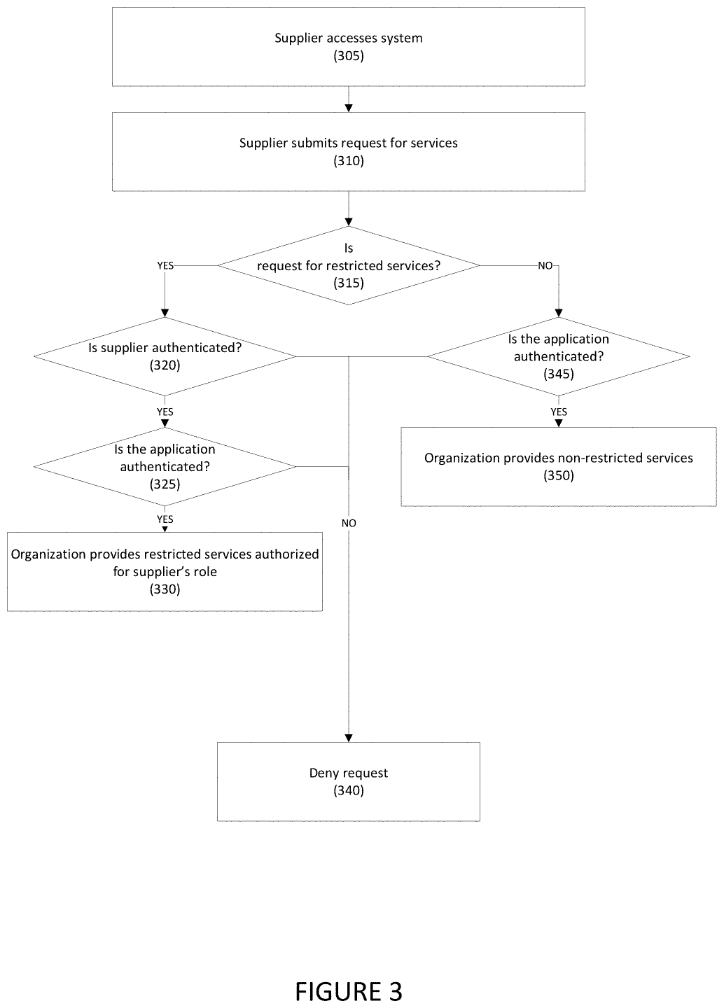

Referring to FIG. 3, an exemplary process flow for a method of providing supplier-requested services is provided according to embodiments. Examples of supplier-requested services may include worker onboarding, invoicing, document upload, supplier set-up, etc.

In step 305, the supplier may access the system. This may be similar to step 205, above.

In step 310, the supplier may request one or more service.

In step 315, if the service is a restricted service, such as worker onboarding, invoice submission, supplier set-up, etc., in step 320, the supplier may be authenticated. This may be similar to step 220, above.

If the supplier is authenticated, in step 325, the application may be checked to see if it is authenticated, such as a registered application, a registered IP address, etc. This may be similar to step 225, above.

If the supplier or the application are not authenticated, in step 340, the request may be denied.

If the application is authenticated, in step 330, the requested service may be provided to the supplier that is authorized for the supplier's and/or the specific requesting individual's role. In one embodiment, each service may have its own interface and entitlements.

If, in step 315, the request is for non-restricted services, in step 345, a check may be made to see if the application is authenticated. This may be similar to step 320. If the application is authenticated, in step 350, the requested service may be provided to the supplier.

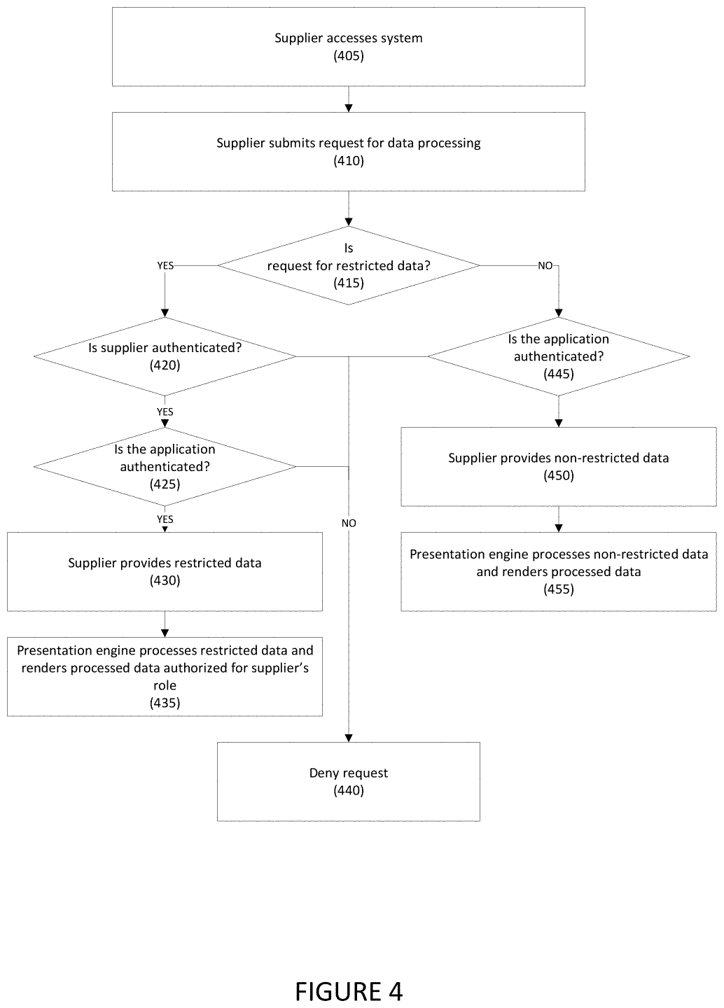

Referring to FIG. 4, an exemplary process flow for a method of providing supplier-requested data aggregation, consolidation, and mapping is provided according to embodiments. In one embodiment, supplier data may be aggregated by region, business line/sub-line, meta or market facing category, or in any manner as is necessary and/or desired.

In step 405, the supplier may access the system. This may be similar to step 205, above.

In step 410, the supplier may request data processing. In one embodiment, the data processing may be for data processing of restricted data or non-restricted data.

In step 415, if the data includes restricted data, in step 420, the supplier may be authenticated. This may be similar to step 220, above.

If the supplier is authenticated, in step 425, the application may be checked to see if it is authenticated, such as a registered application, a registered IP address, etc. This may be similar to step 425, above.

If the supplier or the application are not authenticated, in step 440, the request may be denied.

If the application is authenticated, in step 430, the supplier may provide the restricted data. In one embodiment, all systems of record may be queried for the restricted data. In another embodiment, only systems of record with information relevant to the request may be queried. In another embodiment, machine learning and/or artificial intelligence may be used to identify the systems of record to query.

In one embodiment, data may be de-duplicated as is necessary and/or desired.

In step 435, the requested data processing may be provided to the supplier that is authorized for the supplier's and/or the specific requesting individual's role.

In one embodiment, the data processing may include aggregation of data according to the request. For example, a supplier or internal user may request supplier data by one or more of a region, a line of business/sub-line of business, a calendar year, etc. An internal user may request aggregate data for all suppliers by service category taxonomy hierarchy.

If, in step 415, the request is for non-restricted data processing, in step 445, a check may be made to see if the application is authenticated. This may be similar to step 420. If the application is authenticated, in step 450, the supplier may provide the non-restricted data, and in step 455, the requested service may be provided to the supplier.

In one embodiment, notifications may be provided separately and reflected in the dashboard. In one embodiment, the dashboard may highlight past due and/or upcoming items, may present them priority order, etc.

Embodiments may include a new supplier set-up process. The set-up process may allow third party records in enterprise systems, such as ERP and payment systems, to be mapped (e.g., Information like company address, banking details, remit-to address, etc.).

Embodiments may include a “Find a Supplier” feature, which may use a natural language query, keyword search, etc.) for internal users, to make it easier for a user to find a preferred supplier(s), which may further reduce supplier onboarding cycle time.

Embodiments may include the use of electronic forms (e.g., tax forms) eliminating paper based 1099 forms saving time, money, and boosting sustainability.

Embodiments may provide a “CRM-like” action management and chat room that may improve collaboration thru logging notes, action items, due dates, etc., as well as internal, and external chat capabilities.

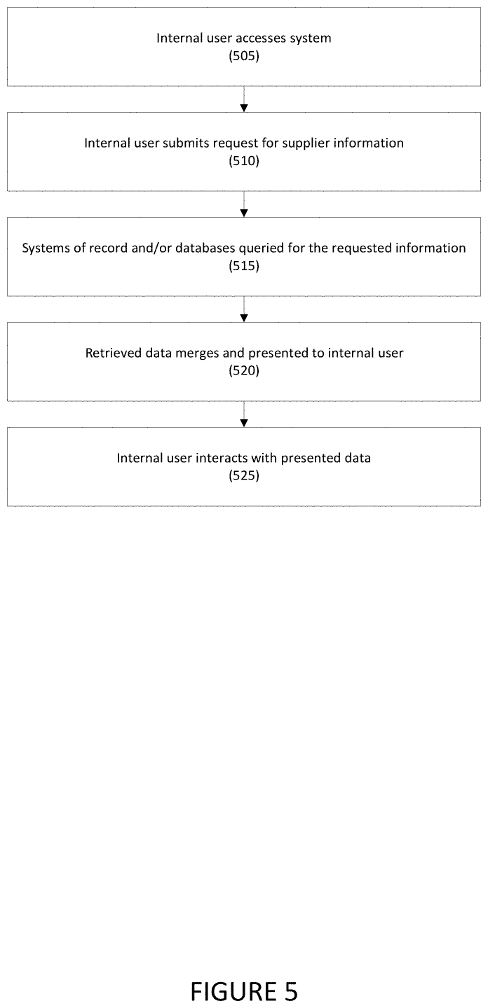

Referring to FIG. 5, a method for internal supplier review may be provided. In step 505, an internal user may access the system. If necessary, the internal user may be authenticated.

In step 510, the internal user may submit a request for supplier information for one or more supplier. In one embodiment, the request may identify specific supplier(s), or it may request a category of suppliers (e.g., suppliers that provide a good/service), suppliers for a line of business, office, region, industry. In one embodiment, if the internal user is responsible for certain suppliers those suppliers, or a subset thereof, may be presented.

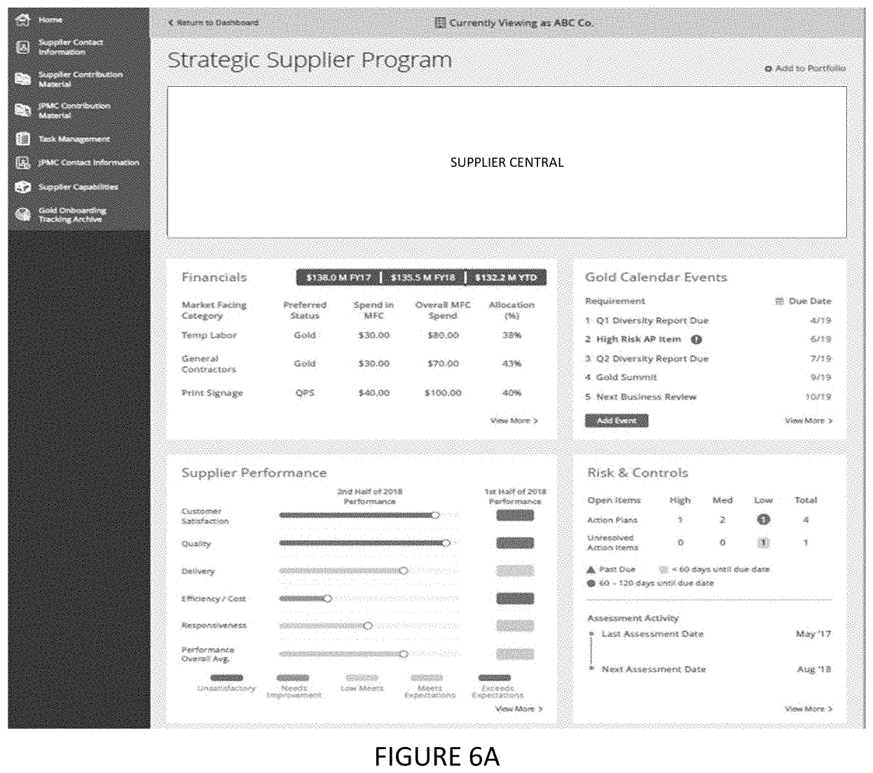

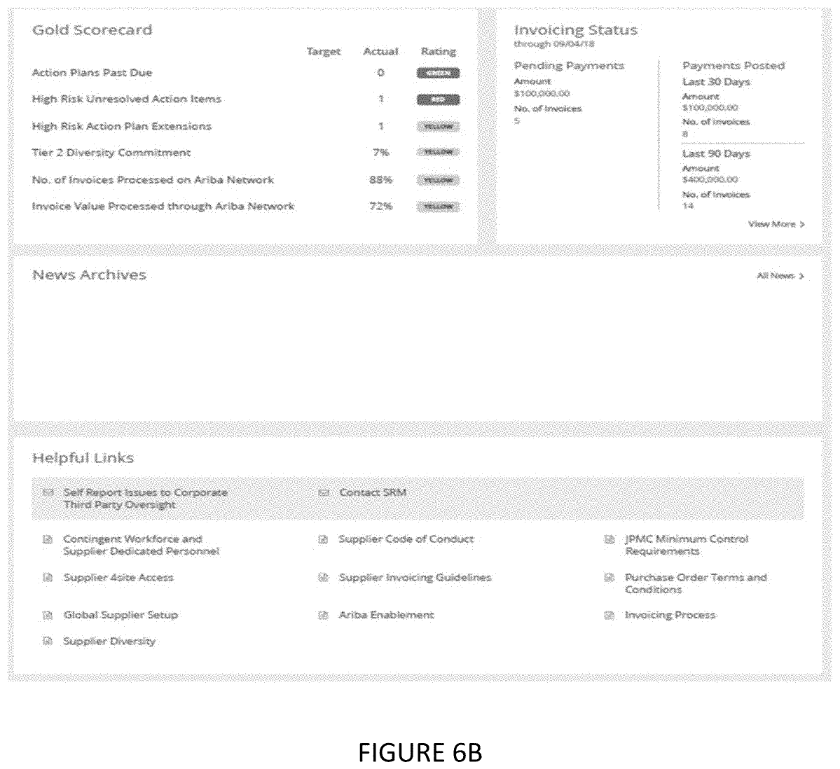

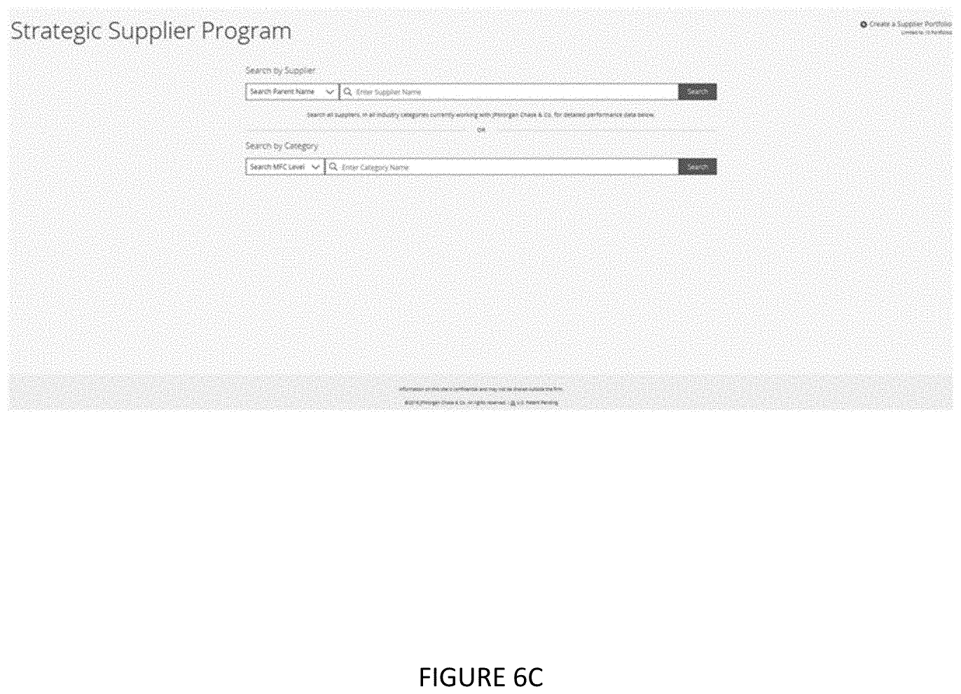

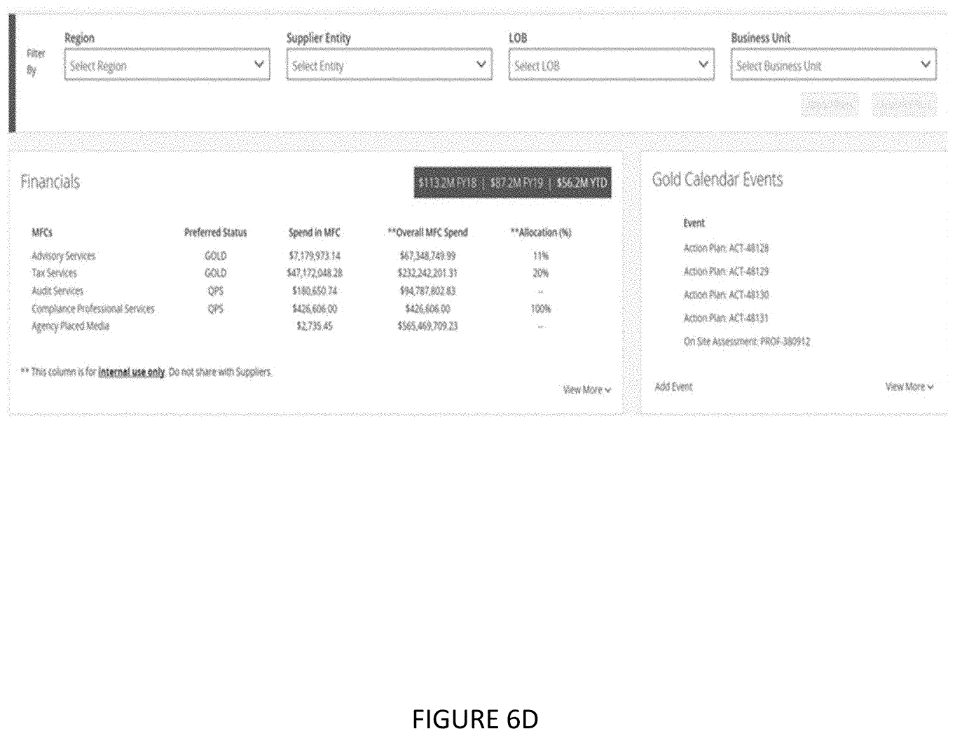

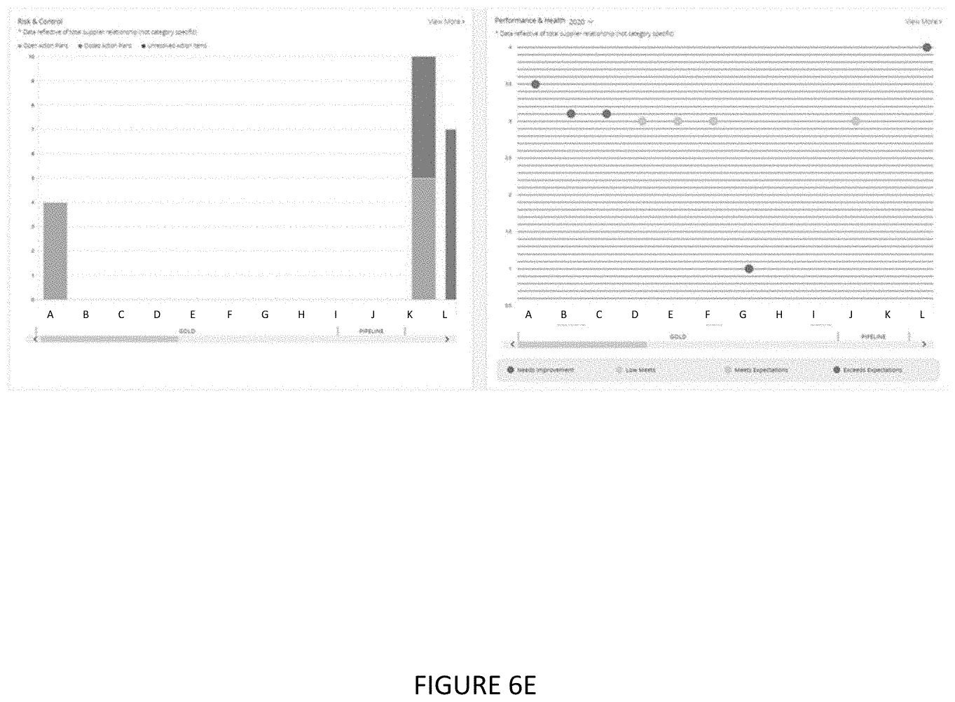

An example search interface is provided in FIG. 6C. The internal user may search by supplier by category.

In one embodiment, the internal user may only receive information to which the internal user is entitled.

In one embodiment, the request may be for specific supplier information, such as supplier performance, risk, usage data, etc. Scores and metrics for the supplier(s) may also be requested.

In step 515, internal systems of record and/or databases may be queried for the requested data. For example, all systems of record and/or databases may be queried. In another embodiment, only systems of record and/or databases with information relevant to the request may be queried. In another embodiment, machine learning and/or artificial intelligence may be used to identify the systems of record and/or databases to query.

In step 520, the data from the systems of record and/or databases may be aggregated and processed. For example, a presentation engine may merge the retrieved information and may present the merged supplier information that the internal user is authorized to view. The information may be presented graphically, and certain information may be highlighted as is necessary and/or desired.

Information for a plurality of suppliers may be presented, for example, side-by-side, or in any suitable manner.

FIGS. 6D and 6E are exemplary graphical representations of the aggregated supplier data. FIG. 6D depicts the data for a single supplier, and FIG. 6E depicts a side-by-side comparison for a plurality of suppliers.

In step 525, the internal use may interact with the data. For example, the internal user may search, tag, and view side by side comparisons of selected suppliers across a number of key attributes, which provides greater data insights and quicker/more effective decision making for internal vendor management and sourcing teams.

Embodiments may include a supplier “Request Feedback” feature to capture real time feedback from stakeholders, boosting supplier performance. Suppliers may also send the organization a survey request.

Embodiments may provide contract terms and legal risks materiality matrix to better inform internal users of exposure with suppliers.

In one embodiment, the organization may provide view of one or more supplier. In one embodiment, organizational users may be presented with supplier metrics, comparisons to other suppliers, etc. The comparison may be presented in a dashboard, and certain metrics (e.g., above or below average) may be highlighted.

In one embodiment, suppliers that provide similar services may be grouped and presented together, along with performance, risk, and other metrics. In one embodiment, preferred and/or potentially preferred suppliers may be identified. In one embodiment, users may select a specific supplier, a metric, a rating, etc. and may receive additional details.

In one embodiment, a concentration, or a percentage of business done with a supplier may be presented. This may assist in identifying potential risks by relying on one supplier too much.

Although multiple embodiments may be disclosed, these embodiments are not mutually exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes disclosed herein.

The processing machine used to implement embodiments may utilize a suitable operating system. Thus, embodiments may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method. Rather, any number of different programming languages may be utilized as is necessary and/or desired.

Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while embodiments present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for providing supplier-requested information, comprising:
in an information processing apparatus comprising at least one computer processor:
receiving a request for information from a supplier representative using a supplier application executed by a supplier electronic device;
authenticating the supplier application;
retrieving the information from a plurality of systems;
aggregating the retrieved information;
determining an entitlement level for the supplier representative; and
communicating the aggregated retrieved information in accordance with the entitlement level to the supplier electronic device.

2. The method of claim 1, further comprising:
determining that the information in the request comprises restricted information comprising at least one of an invoice amount, payment information, an account number, a risk issue, performance data, and a supplier specific scorecard; and
authenticating the supplier representative.

3. The method of claim 2, wherein the authentication comprises full authentication.

4. The method of claim 2, wherein the authentication comprises light authentication.

5. The method of claim 1, further comprising:
determining that the information in the request comprises non-restricted information comprising at least one of an invoice date, an invoice status, a notification, and an alert.

6. The method of claim 1, wherein the step of aggregating the retrieved information comprises merging the retrieved information from the plurality of systems into a single graphical representation.

7. The method of claim 1, wherein the supplier application is authenticated if it is a registered application.

8. The method of claim 1, wherein the aggregated retrieved information is graphically presented in a dashboard.

9. The method of claim 1, wherein the requested information comprises a request for data aggregation, consolidation, or mapping.

10. A method for providing supplier-requested services, comprising:
in an information processing apparatus comprising at least one computer processor:
receiving a request for a service from a supplier representative using a supplier application executed by a supplier electronic device;
authenticating the supplier application;
determining an entitlement level for the supplier representative; and
providing access to the service in accordance with the entitlement level on the supplier electronic device.

11. The method of claim 10, further comprising:
determining that the requested service is a restricted service comprising at least one of worker onboarding, invoice submission, or supplier set-up; and
authenticating the supplier representative.

12. The method of claim 11, wherein the authentication comprises full authentication.

13. The method of claim 11, wherein the authentication comprises light authentication.

14. The method of claim 10, further comprising:
determining that the service is a non-restricted service; and
providing access to the non-restricted service on the supplier electronic device.

15. A method for providing internal supplier review information, comprising:
in an information processing apparatus comprising at least one computer processor:
receiving a request for supplier information from an internal user using an internal user application executed by an electronic device;
retrieving the supplier information from a plurality of systems;
aggregating the retrieved supplier information; and
communicating the aggregated supplier information in accordance with the entitlement level to the electronic device;
wherein the aggregated supplier information is graphically presented on the electronic device.

16. The method of claim 15, wherein the request identifies a specific supplier.

17. The method of claim 15, wherein the request identifies a category of suppliers.

18. The method of claim 15, wherein the request is for supplier information comprising at least one of performance, usage data, and risk.

19. The method of claim 15, wherein certain information in the aggregated supplier information is displayed in a highlighted manner.

20. The method of claim 15, wherein the aggregated supplier information comprises aggregated supplier information for a plurality of suppliers.
